(19) United States
(12) Patent Application Publication
(10) Pub. No.: US 2006/0292448 A1
(43) Pub. Date: Dec. 28, 2006

(54) Current Collector Structure and Methods to Improve the Performance of a Lead-Acid Battery

(76) Inventors: Elod Gyenge, Vancouver (CA); Joey Jung, Delta (CA); Alvin A. Snaper, Las Vegas, NV (US)

Correspondence Address: KEVIN J. MCNEELY, ESQ., 5335 WISCONSON AVENUE, NW, SUITE 440, WASHINGTON, DC, 20015, US

(21) Appl. No.: 11/426,892

(22) Filed: Jun. 27, 2006

Related U.S. Application Data
(63) Continuation of application No. 11/279,103, filed on Apr. 8, 2006.
(63) Continuation of application No. 11/048,104, filed on Feb. 2, 2005.

(51) Int. Cl. H01M 4/80

(52) U.S. Cl. 429/236

(57) ABSTRACT

A current collector of a battery includes a reticulated substrate having a circuitous network of pores and a metal applied to at least a portion of the reticulated substrate. The reticulated substrate may be a non-metal foam substrate, such as, for example, a carbon foam substrate, a reticulated vitreous carbon substrate or a graphite foam substrate.

### CROSS-REFERENCE TO RELATED APPL1ICATIONS

This utility patent application is a continuation of co-pending U.S. patent application Ser. No. 11/279,103 filed on Apr. 8, 2006 and 11/048,104 filed on Feb. 2, 2005, which were co-pending with application Ser. No. 10/809,791 filed on Mar. 26, 2004, which was co-pending with PCT/US2002/30607 filed on Sep. 25, 2001, which was co-pending with and claims the benefit of United States Provisional Application 60/325,391 filed Sep. 26, 2001, which are all incorporated by reference herein.

### FIELD OF THE INVENTION

This invention relates generally to electrodes and particularly to high surface area electrodes which improve the performance of batteries in one or more ways alone or in combination such as: specific discharge capacity, positive active mass utilization, and discharge/recharge cyclability.

### BACKGROUND OF THE INVENTION

Batteries have been used for diverse applications such as starting-lighting-ignition (SLI), uninterrupted power supply (UPS) and motive power. Continuous developments on the application side, for instance in the area of electric vehicles and hybrid electric vehicles (EV and HEV), impose challenging performance demands on battery technologies in general and lead acid batteries in particular. Pavlov summarized the relationship between battery specific energy in watt hours/kilogram (Wh/kg) and number of battery discharge/charge cycles for both flooded and valve-regulated type lead acid batteries. For both battery types, the higher the battery specific energy the lower the number of discharge/charge cycles and hence, the battery cycle life. Typically, a flooded battery with a specific energy of 40 Wh/kg can be used for about 500 discharge/charge cycles, while a battery producing only 30 Wh/kg can be employed for about 850 cycles. Thus, there is a need to improve both the specific energy and cycle life of batteries in order to make them more suitable for electric traction applications.

The low utilization efficiency of the active mass, especially on the positive electrode, in conjunction with the heavy weight of the lead current collectors, limits the actual specific energy of a lead-acid battery. The structure of the current collector plays an important role in determining the utilization efficiency of the positive active mass (PAM). During discharge, on the positive electrode, the structure of the current collector must allow for significant volume increase (e.g. molar ratio of PbSO₄ to PbO₂ is 1.88) while maintaining electrical contact with the active material and assuring ionic transport to the electroactive sites.

### SUMMARY OF THE INVENTION

The present invention relates to methods of improving the performance, especially cycling performance, of batteries by using current collector structures based on light-weight, porous, open pore, high specific surface area (e.g. >500 m²/m³) reticulated substrates, such as, for example, a foam substrate, at least partially coated with a metal alloy. More specifically it relates to the use of metal alloys deposited on lightweight, open pore substrates such as carbon foam or aluminum foam to dramatically enhance the cyclability of the subsequent high surface area electrode for use as a positive and/or negative electrode in lead acid batteries.

The present invention provides an improved current collector structure for generating power in a battery. The current collector is comprised of a reticulated, light-weight, electronically conductive three-dimensional substrate matrix characterized by high specific surface area (i.e., between 5×10² and 2×10⁴ m²/m³ ) and void fraction (i.e. between 70 and 98%). A number of materials could serve as the above-mentioned substrate, such as, for example, reticulated carbon, such as for example, carbon foam or graphite foam, aluminum, copper and/or other organic foams, either alone or in combination.

Furthermore, the structure may include a metal layer such as lead-tin or other metal alloy deposited on the heaviest current carrying surfaces, such as, for example, on the tab or other electrical interconnection or current carrying interface and, in one embodiment, throughout the surface and depth of the three-dimensional reticulated matrix to uniformly cover the ligaments of the substrate matrix. The thickness of the deposited metal alloy layer can range for example between 20 to 2000 μm, depending on the intended application and battery cycle life. The resulting composite structure composed of the light-weight matrix partially or completely covered by a layer of metal alloy, is used as the positive and/or negative current collector in lead-acid batteries. It is understood for those skilled in the art that in order to obtain a functional lead-acid battery the above-described collectors might be subjected to pasting with any variety of potentially active materials, such as, for example, lead oxide and/or lead sulfate based pastes. The electrode formed by pasting the current collector is brought into contact with sulfuric acid or other acid solution of desired concentration and assembled in any type of flooded, absorbed glass mat or valve-regulated lead-acid batteries. After forming (initial charging), the paste is converted into an active material (or active mass) which, in one embodiment, is lead dioxide on the positive electrode and lead on the negative electrode, respectively. When the lead-acid battery is subjected to discharge both the lead dioxide on the positive electrode and the lead on the negative electrode are converted to lead sulfate and current is transferred via the current collector (coated substrate) to a consumption source (load). During charge, direct current (DC) is supplied to lead sulfate by the current collector and the active materials are regenerated. Thus, the interaction of the current collector with the active mass is a feature for the functioning of the lead-acid battery for the described embodiment.

In one general aspect, a current collector of a battery includes a reticulated substrate having a circuitous network of pores and a metal applied to at least a portion of the reticulated substrate.

Embodiments may include one or more of the following features. The reticulated substrate may be a non-metal foam substrate, such as, for example, a carbon foam substrate, a reticulated vitreous carbon substrate or a graphite foam substrate.

The reticulated substrate may have more than 10 pores per square inch of surface area.

The metal applied to the reticulated substrate may be a metal alloy, such as for example, a lead-tin alloy layer that coats at least a portion of the reticulated substrate. The metal applied to the reticulated substrate may also be an electrical connection element or other current-carrying interface connected or attached to the reticulated substrate. The metal applied to the reticulated substrate may also be a frame attached to an outer edge of the foam substrate.

In a further general aspect, a battery electrode includes a reticulated substrate having a circuitous network of pores, a metal on at least a portion of the reticulated substrate and an active paste on at least a portion of the reticulated substrate.

Embodiments may include one or more of the above or following features. The reticulated substrate may be a non-metal foam substrate, such as, for example, a carbon foam substrate.

The metal may be a metal alloy layer applied to the portion of the reticulated substrate. The active paste may be a lead paste applied to the portion of the reticulated substrate or on the metal alloy layer.

In still another general aspect, a battery includes a housing, a pair of electrodes fixed within the housing, at least one of the electrodes having a reticulated substrate with a circuitous network of pores, a metal applied to each of the electrodes as a current carrying interface, and an active material applied to at least a portion of the foam substrate, an electrolyte to contact the electrodes and terminal connections connected to the electrodes.

Embodiments may include one or more of the above or following features. For example, the reticulated substrate may be a non-metal foam substrate. The non-metal foam substrate may be a metal alloy layer applied to at least a portion of the foam substrate.

As another feature, the reticulated substrate may be a several plates or panes with a structural member interposed between each reticulated substrate. The structural members may be made of metal and may be bonded to adjacent reticulated substrates.

### BRIEF DESCRIPTION OF THE DRAWINGS

FIG. 1A is a front view schematic of the current collector according to one embodiment of this invention;

FIG. 1B is a front view schematic of the current collector according to another embodiment of this invention;

FIG. 1C is a front view schematic of the current collector according to an alternative embodiment of the present invention;

FIG. 2 is a scanning electron microscopy image of the high-specific surface area, reticulated part of the current collector structure according to one embodiment of this invention;

FIG. 3 shows a cross-sectional view, obtained by backscattered electron microscopy of the current collector structure according to the present invention;

FIG. 4 compares the early stage cycling performance of pure lead and lead-tin (99:1 weight ratio of lead to tin) coated current collectors manufactured according to the present invention;

FIG. 5 compares the nominal specific capacity (Peukert diagram) for the limiting positive electrode for the lead-tin electroplated reticulated vitreous carbon manufactured according to the present invention and book-mould current collector designs; and

FIG. 6 shows the cycling performance with respect to the positive limiting electrode for a flooded single cell 2-volt battery equipped with lead-tin electroplated vitreous carbon current collectors manufactured according to the present invention.

### DETAILED DESCRIPTION

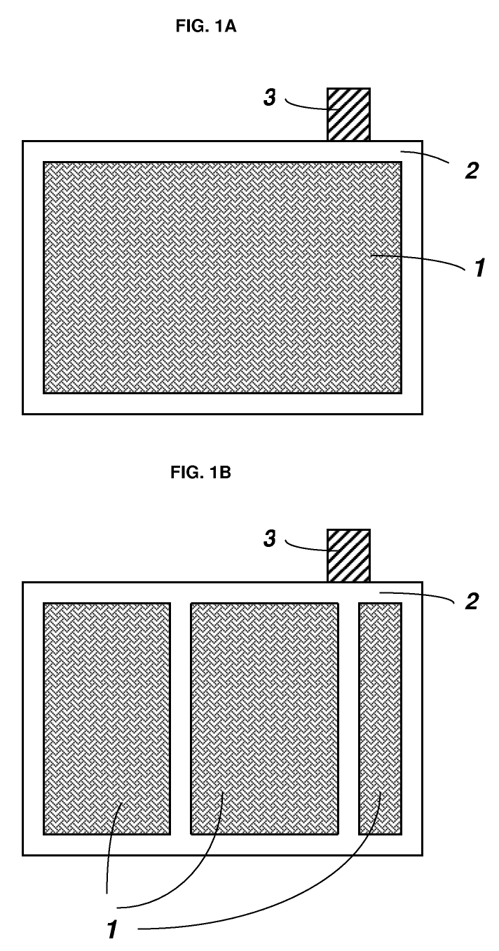

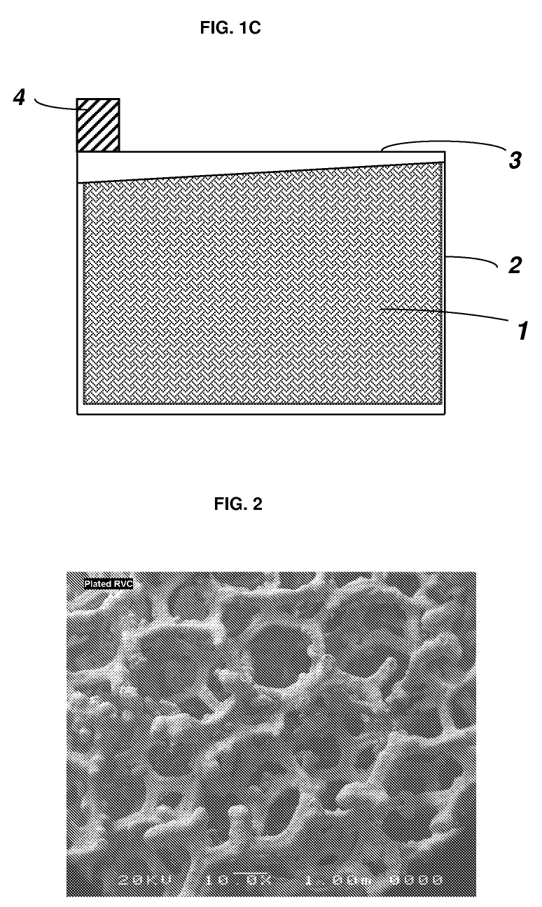

FIG. 1A represents a front view of the current collector structure according to one embodiment of the present invention. Denoted by reference numeral 1 is the high specific surface area reticulated substrate. In one embodiment, a metal layer is deposited on all or a portion of the substrate. For example, lead or lead-alloys may be deposited on the electrically conductive, reticulated substrate, which may be reticulated vitreous carbon. The high specific surface area part is attached to a frame 2, which in turn is connected to a lug or tab 3. Both the frame 2 and tab 3 may be made of lead, a lead-alloy or other metal alloy.

In another embodiment, shown by FIG. 1B, the reticulated part 1 is compartmentalized by intercalated strips or other structural members which are part of the overall frame structure 2. The compartmentalization can improve the current and potential distribution characteristics across the high specific surface area component of the current collector structure, especially in case of larger plate designs and may also improve the structural integrity of a larger plate.

A further design variation is presented by FIG. 1C. In this case the top connector 3 has a triangular design, gradually widening toward the edge of the collector, where lug or tab 4 is situated. This design feature combines the need for weight reduction of the connector with good corrosion resistance in the area of highest current concentration, that is, the current entry and exit zone 4. The frame 2 around the reticulated structure can be of similar or different width. A wider frame can be used on the side that is in contact with the tab 4 and a thinner frame may be attached on the opposite side (FIG. 1C).

A scanning electron microscopy image of the reticulated part of the collector is shown by FIG. 2. In this particular case reticulated vitreous carbon with 30 pores per inch (ppi) served as substrate and it was plated with a lead alloy. In other embodiments, materials with a different pore density, such as 10-20 ppi, may be used. FIG. 2 shows the interconnected, open-cell network, which forms the physical basis for current transfer to and from the active mass. The active mass covers the surface of the substrate elements or wires and also occupies the pores or openings of the reticulated structure. The proximity of the current collector wires or elements to the active mass (for example, the diameter of the openings in the case depicted in FIG. 2 is about 2 mm) leads to enhancement of the active mass utilization efficiency and charge acceptance.

1. Manufacturing the Reticulated Substrate

In one embodiment of the present invention, reticulated vitreous carbon (RVC) slabs with 20 and 30 pores per inch (about 8 and 12 pores per centimeter, respectively) were used as substrates for grid manufacturing. An RVC slab having dimensions of 15.2 cm×15.2 cm×12.8 mm (height×width×thickness) was sliced to a preferred thickness of about 3.5 mm with a steel cutter. After slicing, the height and width of the carbon foam slab was adjusted to the size needed for the particular battery. For example, one commonly employed current collector sizes is 12.7 cm×12.7 cm (height×width).

After size adjustment, the vitreous carbon substrate was coated with a layer of a lead-tin alloy. However, in other embodiments, a metal alloy not applied or other types of metal alloys may be used. A variety of methods can be used for the deposition of lead-tin alloys on carbon-based substrates, such as electroplating and vacuum deposition. In the present embodiment electroplating or electrodeposition was chosen to apply the lead-alloy coating on the RVC substrate. However, it is understood to those skilled in the art that other methods might be used to coat RVC with a metal alloy.

In the case of the electroplating method, in order to supply current to the vitreous carbon structure during electroplating, a 2.5 mm thick connector and 6 cm×1.3 cm (height×width) lug or tab, both made of 99.8% by weight purity lead, were attached to the reticulated carbon slab. This was accomplished by immersing the top part of the carbon piece in melted lead at 37° C. using aluminum molds, followed by rapid cooling by an air-jet. Other lead or metal alloys may also be used as the current carrying interface.

To electroplate lead on reticulated vitreous carbon, there are several lead electroplating bath compositions, such as fluoborate, sulfamate, and fluosilicate. In the present example the fluoborate bath was used. However, it is understood to those skilled in the art that other electroplating bath formulations could be considered. For the electroplating of a pure lead coating on the RVC substrate the fluoborate bath per one liter of stock solution was composed of: 500 ml of 50% by weight lead tetrafluoroborate (Pb(BF₄)₂), 410 ml of deionized water, 27 g of boric acid (H₃BO₃), 90 ml of fluoboric acid (HBF₄), and 3 g of peptone. During preparation the plating solution was mixed at room temperature.

To electroplate a lead-tin alloy on the RVC substrate, the lead electroplating bath composition was modified by the addition of various concentrations of tin tetrafluoroborate. The concentration of tin in the plating bath determines to large extent the tin content of the lead alloy. The typically employed lead-tin alloy electroplating solutions had the following composition per one liter of stock solution: between 74 and 120 ml of 50% by weight tin tetrafluoroborate (Sn(BF₄)₂) solution, 510 ml of 50% by weight lead tetrafluoroborate (Pb(BF₄)₂) solution, between 330 and 376 ml of deionized water, 27g of boric acid (H₃BO₃), 40 ml of fluoboric acid (HBF₄), and 1 g of gelatin. During electroplating the tin content of the plating bath was kept constant either by using a sacrificial lead-tin anode or by adding at certain time intervals, fresh tin tetrafluoroborate solution.

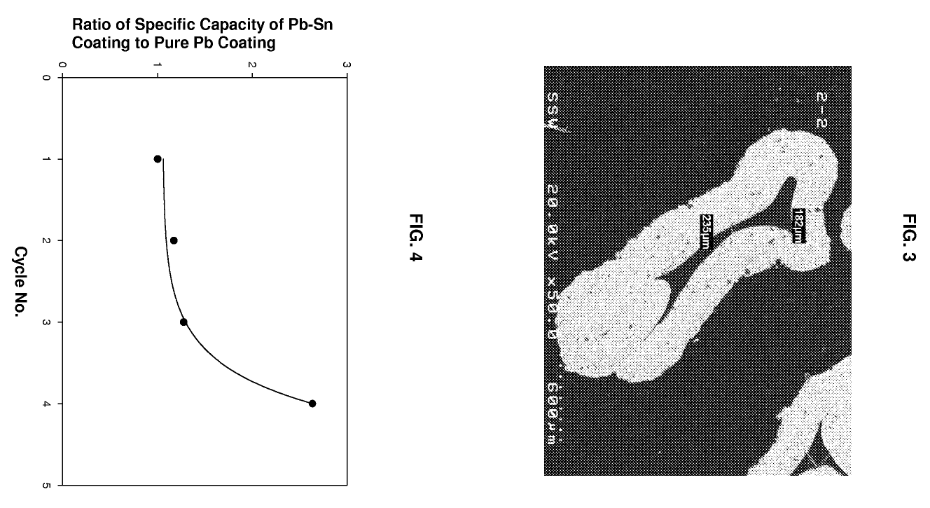

The RVC plate was placed in the electroplating bath and acted as the cathode, while two 80/20 (by weight of lead to tin) lead-tin plates of 3.2 mm thickness acted as sacrificial anodes sandwiching the RVC cathode. The distance between the RVC cathode and the lead-tin anode was 3.8 cm. The cathode and anode had similar geometric areas. Following immersion in the electroplating bath, the electrodes were connected to a DC power supply characterized by a maximum voltage and current output of 25 V and 100 A, respectively. The typical electroplating conditions for either lead or lead-tin electroplating on RVC were as follows: current density 570 A/m², cell voltage 0.3-0.7^{V}, temperature 20-2520 C. The coating thickness was adjusted by varying the plating time (typically between 1 and 2 hours). The required lead or lead alloy coating thickness is a function of the intended battery type, application and electrode polarity. For the flooded lead acid battery the negative collector was produced with a 30-50 μm thick coating while the coating on the positive collector had a thickness of 200-500 μm. By employing a different coating thickness on the negative and positive electrodes or by eliminating the coating on one of the electrodes, depending on the need for structural integrity, both the weight saving and long cycle life objectives can be simultaneously achieved. FIG. 3 shows the back scattered electron microscopy image of the cross section for the plated reticulated vitreous carbon. The plated reticulated vitreous carbon has a lead-tin coating of 235 μm thickness to produce, for example, the positive collector.

After the electroplating was completed, the plated RVC was subjected to a sequential washing procedure in the following order: distilled water rinse, alkaline wash (0.1 M NaOH), distilled water wash, acetone wash and acetone dipping. Drying in a nitrogen atmosphere followed the last washing step. The described procedure assured complete removal of the electroplating bath components from the high surface area collector while minimizing the surface oxidation. In the case of lead alloy deposition the typical tin content of the collectors was between 0.5-2% by weight tin. It is understood to those skilled in the art that other coating tin contents can be easily achieved by adjusting the plating time, current density and/or plating bath composition.

Following the electroplating, washing and drying steps the current collector was further processed by replacing the tab, which served as a current feeder during electroplating, with a wider top connecting element that in one embodiment of the present invention had a triangular shape as shown by FIG. 1C. Additionally, three frames were also attached on the sides of the electroplated RVC plate. The process of attaching the new connector and frames was similar to the one described before for attaching the electroplating connector. The material for the battery grid tab and frames was a lead alloy containing 2% by weight of tin.

2. Battery Cycling Performance

In order to compare the performance of the pure lead and lead-tin alloy reticulated collectors, two flooded, single cell, 2 V, batteries were assembled, equipped with pasted plates using pure lead and lead-tin (1% by weight of tin) coated collectors, respectively. The pure lead and lead-tin coated collectors were manufactured according to the procedure described above. The following table summarizes the plating recipes and plating conditions.

TABLE 1
Electroplating Conditions.

| | Lead | Lead | Lead-Tin | Lead-Tin |
|---|---|---|---|---|
| | Coated | Coated | Coated | Coated |
| | Positive | Negative | Positive | Negative |
| Recipe per one liter | 500 ml of 50% by | | 74 ml of 50% by | |
| of electrolyte | weight Pb(BF₄)₂; | | weight Sn(BF₄)₂, | |
| | 410 ml of deionized | | 510 ml of 50% by | |
| | water, 27 g of H₃BO₃, | | weight Pb(BF₄)₂, | |
| | 90 ml of HBF₄, and | | 376 ml of deionized | |
| | 3 g of peptone | | water, 27 g of H₃BO₃, | |
| | | | 40 ml of HBF₄, and | |
| | | | 1 g of gelatin | |
| Current Density (A/m²) | 570 | 570 | 570 | 570 |
| Plating Temperature | 25 | 25 | 25 | 25 |
| (° C.) | | | | |
| Plating Time (Hr) | 2.5 | 1 | 2.5 | 1 |
| Coating Thickness (μm) | ˜235 | ˜95 | ˜235 | ˜75 |

| | | |
|---|---|---|
| Size (cm × cm × mm) | 12.7 × 12.7 × 3.5 | 12.7 × 12.7 × 3.5 |

Each battery was composed of two negative and one positive reticulated collector pasted with a lead-acid battery paste composed of lead sulfate, lead monoxides and lead dioxide. Two single-cell batteries were assembled using the respective battery plates, such as, for example, cured pasted collectors. First the battery plates were formed in dilute sulfuric acid (specific gravity 1.05) by applying a constant current charge in order to supply a charge of 520 Ah/kg_{dry}_paste in 72 hours. The forming step is necessary to create the active materials on the plates, such as, for example, Pb on the negative and PbO₂ on the positive.

The testing protocol was comprised of consecutive daily cycles at 5 hour discharge rate with cut-off voltage at 1.5 V followed by 19 hour recharge at a float voltage of 2.35 V/cell using sulfuric acid with an initial specific gravity of 1.26. The above protocol is relevant for deep cycling of stand-by batteries and it is considered an extreme level of cycling for the latter battery type. FIG. 4 shows the comparison cycling characteristics of the two batteries. After first 4 days of cycling, the specific capacity of the pure lead plated RVC battery dropped, i.e. the specific capacity of lead-tin alloy electroplated RVC battery was 2.6 times higher of the specific capacity of pure lead plated RVC battery.

The results presented in FIG. 4 underline the beneficial effect of tin as an alloying element for stabilizing the capacity of deep-cycle lead-acid in the early stages of cycling.

3. Performance Comparison With Book-Mould Grids

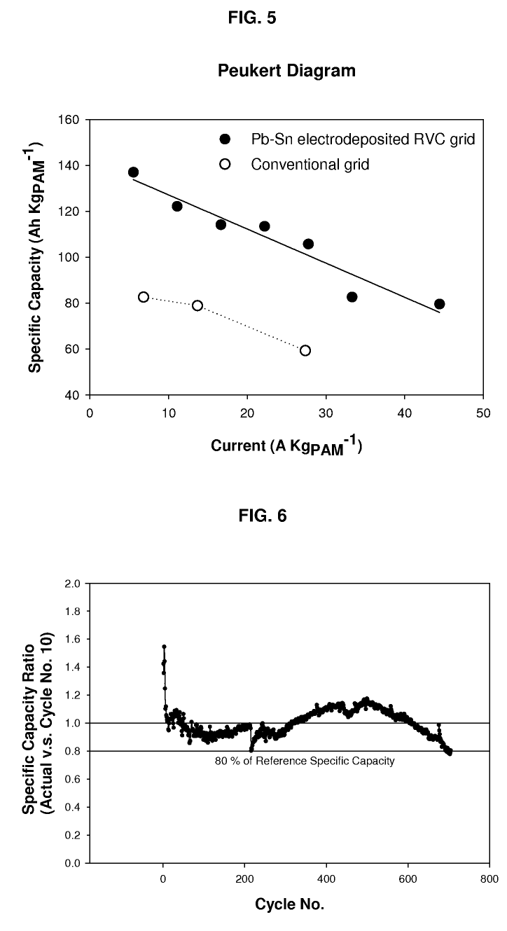

The comparative nominal capacities, Peukert diagram, for the performance limiting positive electrode in the case of two flooded single-cell 2 V batteries employing book-mould and lead-tin (1% by weight of tin) electrodeposited RVC collectors, respectively, is shown by FIG. 5. Both battery types were pasted, assembled and formed under identical conditions. The lead-tin electrodeposited reticulated grids were prepared according to the method described above. The employed discharge currents corresponded to discharge rates between 24 to 2 h for the positive limited electroplated RVC collector battery and 12 to 2 h for the book-mould grid battery, respectively (FIG. 5).

Discharging the two batteries at a current of 27.5 A/kg_{PAM}, the specific discharge capacity of the positive plate using the electrodeposited RVC collector was 105.7 Ah/kg_{PAM} (utilization efficiency of 47.2%), while in the case of the book-mould collector only 59.3 Ah/Kg_{PAM} was obtained indicating a low utilization efficiency of the positive active mass, i.e. 26.2% (FIG. 5). Therefore, the specific capacity of the positive plate with electroplated reticulated collector was 78% higher than the capacity of the plate that used an industry standard book-mould grid.

At a discharge current of 6 A/Kg_{PAM the specific capacity of the electroplated RVC positive plate was} 66% higher than in the case of book-mould grid. The improvement of the positive active mass utilization efficiency and specific capacity of the limiting positive electrode is directly correlated with the enhancement of the specific energy of the battery. Based on the presented results the specific energy of a flooded lead-acid battery equipped with electroplated RVC collectors was 62.7 Wh/kg at a discharge rate of 20 hrs. Under similar conditions a battery equipped with book-mould collectors would provide only 39.1 Wh/kg. This clearly shows the significant performance improvement obtained by using lead-tin electroplated RVC current collectors in lead-acid batteries.

4. Cycle Life of a Flooded Battery Equipped With Reticulated Current Collectors

A test cell composed of one positive and two negative pasted electroplated lead-tin RVC electrodes was subjected to long-term cycling. The electrodes were prepared by the method described above. Each cycle comprised of a discharge at 63 A/Kg_{PAM} (nominal utilization efficiency 21% and 0.75 h rate) followed by a two-step constant current charge at 35 A/Kg_{PAM} and 9.5 A/Kg_{PAM}, respectively, with a cut-off voltage at 2.6 V. The returning charge was 105-115% of previous discharge.

FIG. 6 shows the cycling performance of the battery under the above conditions. Using the specific capacity of cycle 10 as a reference, the lead-tin (1% by weight tin) electrodeposited RVC battery completed 706 cycles above or at 80% of the reference specific capacity, corresponding to over 2100 h of continuous operation. The above experiment indicates therefore, that lead-tin electrodeposited RVC electrodes are capable of providing long battery cycle life. However, it should be noted that other metal alloys may be used.

5. Comparative Testing With Reticulated Aluminum Collectors

In one embodiment trial, reticulated metal foams such as aluminum foam with 20 pores per inch was used as substrate for grid manufacturing. The reticulated aluminum foam having dimensions of: 12.2 cm×15.2 cm×5.9 mm (height×width×thickness) was first immersed in a zinc enriched solution for 3 minutes and then coated with a layer of lead-tin alloy using the method described above. It is understood to those skilled in the art that the metal coating may be omitted or other metal or lead coating methods can also be employed to produce lead deposited reticulated aluminum current collectors. Two negative and one positive lead electrodeposited aluminum collector was pasted and assembled to form a single cell flooded 2 V battery. For comparative testing purposes another single cell flooded battery was assembled and formed in an identical fashion but equipped with industry standard book-mould collectors. Table 2 compares the discharge current, the specific capacity of the positive limiting plate, and the utilization efficiency of the positive active mass (PAM utilization efficiency) in the case of the 20 h discharge rate.

TABLE 2
Comparison between book-mould and electroplated aluminum
current collectors in flooded single cell 2 V batteries.

| | | Lead-tin |
|---|---|---|
| | Book-mould | electrodeposited |
| | collector | reticulated aluminum |
| Discharge time (h) | 20 | 20 |
| Discharge current (A/kg_{PAM}) | 2.7 | 5.8 |
| Discharge capacity (Ah/kg_{PAM}) | 55.1 | 116.1 |
| PAM utilization efficiency (%) | 24.6 | 51.8 |

The PAM utilization efficiency and discharge capacity of the lead electrodeposited reticulated aluminum electrode was 42% higher than for the book-mould electrode. This example shows that high specific surface area reticulated metals can also serve as substrates for lead or lead-alloy deposited battery current collectors.

6. Single or Multi-Layer Open Pore Substrates Other than reticulated substrates such as foam, which are open pore multi-layer substrates, the following non-limiting additional types of substrates can be considered. For example, single or multi-layer screen(s) coated with lead or lead-tin alloy could be considered. The difference in these two types of substrates is in the number of struts or elements that connect the pores and the geometric symmetry of the struts or elements. For example, there are typically three strut joints in reticulated versus typically four strut joints in screens. Also, certain types of reticulated substrates, such as, for example, foam substrates, may also be characterized in having an asymmetric or random network of circuitous pores as compared to conventional geometrically symmetric grid elements.

Other embodiments of the invention are within the scope of the following claims.

1. A current collector of a battery, comprising:
a reticulated substrate having a network of pores; and
a metal applied to at least a portion of the reticulated substrate.

2. The current collector of claim 1, wherein the reticulated substrate comprises a non-metal foam substrate.

3. The current collector of claim 2, wherein the non-metal foam substrate comprises a carbon foam substrate.

4. The current collector of claim 3, wherein the carbon foam substrate comprises a reticulated vitreous carbon substrate.

5. The current collector of claim 3, wherein the carbon foam substrate comprises a graphite foam substrate.

6. The current collector of claim 1, wherein the reticulated substrate comprises more than 10 pores per square inch of surface area.

7. The current collector of claim 1, wherein the metal applied to the reticulated substrate comprises a metal alloy.

8. The current collector of claim 7, wherein the metal alloy comprises a lead-tin alloy layer that coats at least a portion of the reticulated substrate.

9. The current collector of claim 1, wherein the metal applied to the reticulated substrate comprises an electrical connection element.

10. The current collector of claim 1, wherein the metal applied to the foam substrate comprises a current-carrying interface attached to the reticulated substrate.

11. The current collector of claim 1, wherein the metal applied to the reticulated substrate comprises a current-carrying interface connected to the reticulated substrate.

12. The current collector of claim 1, wherein the metal applied to the reticulated substrate comprises a frame attached to an outer edge of the foam substrate.

13. The current collector of claim 1, wherein the reticulated substrate comprises a first reticulated substrate and a second reticulated substrate and further comprising:
a structural member interposed between the first reticulated substrate and the second reticulated substrate.

14. The current collector of claim 13, wherein the structural member comprises a metal structural member bonded to the first reticulated substrate and the second reticulated substrate.

15. An battery electrode, comprising:
a reticulated substrate having a network of pores;
a metal on at least a portion of the reticulated substrate; and
an active paste on at least a portion of the reticulated substrate.

16. The battery electrode of claim 15, wherein the reticulated substrate comprises a non-metal foam substrate.

17. The battery electrode of claim 16, wherein the non-metal foam substrate comprises a carbon foam.

18. The battery electrode of claim 15, wherein the metal comprises a metal alloy layer applied to the portion of the reticulated substrate.

19. The battery electrode of claim 15, wherein the active paste comprises a lead paste applied to the portion of the reticulated substrate.

20. The battery electrode of claim 19, wherein:
the metal comprises a metal alloy layer applied to the portion of the reticulated substrate; and
the active paste comprises an active paste to coat the metal alloy layer.

21. The battery electrode of claim 15, wherein the reticulated substrate comprises a first reticulated substrate and a second reticulated substrate and further comprising:
a structural member interposed between the first reticulated substrate and the second reticulated substrate.

22. A battery, comprising:
a housing;
a pair of electrodes fixed within the housing, at least one of the electrodes having a reticulated substrate with a network of pores, a metal applied to each of the electrodes as a current carrying interface, and an active material applied to at least a portion of the reticulated substrate;
an electrolyte in contact with the electrodes; and
terminal connections connected to the electrodes.

23. The battery of claim 22, wherein the reticulated substrate comprises a non-metal foam substrate.

24. The battery of claim 22, further comprising a metal alloy layer applied to at least a portion of the foam substrate.

25. The battery of claim 22, wherein the reticulated substrate comprises a first reticulated substrate and a second reticulated substrate and further comprising:
a structural member interposed between the first reticulated substrate and the second reticulated substrate.
